(19) United States
(12) Patent Application Publication
(10) Pub. No.: US 2017/0062102 A1
(43) Pub. Date: Mar. 2, 2017

(54) METHOD FOR MANUFACTURING BLIND HOLE OF INSULATING SUBSTRATE FOR ELECTRONIC DEVICE

(71) Applicants: General Interface Solution Limited, Miaoli County (TW); Interface Optoelectronics (ShenZhen) Co., Ltd., Shenzhen (CN)

(72) Inventors: Chun-Te CHANG, Guangdong (CN); Yu-Pi KUO, Guangdong (CN); Chung-Wu LIU, Guangdong (CN); Wei-Chung CHUANG, Guangdong (CN)

(21) Appl. No.: 14/972,107

(22) Filed: Dec. 17, 2015

(30) Foreign Application Priority Data
Sep. 2, 2015 (CN) 201510557280.0

(51) Int. Cl. H01B 19/04; H01B 3/08; C03C 15/00

(52) U.S. Cl. CPC H01B 19/04; C03C 15/00; H01B 3/088

(57) ABSTRACT

The present disclosure provides a method for manufacturing a blind hole of an insulating substrate for an electronic device. The method includes following steps. A patterned photoresist layer is formed over the insulating substrate. The patterned photoresist layer has an opening exposing a portion of the insulating substrate. A wet etching process is performed to remove the exposed insulating substrate to form a blind hole in the opening.

### RELATED APPLICATIONS

This application claims priority to Chinese Application Serial Numbers 201510557280.0, filed Sep.02, 2015, which is herein incorporated by reference.

### BACKGROUND

Field of Invention

The present disclosure relates to a method for manufacturing a blind hole of an insulating substrate for an electronic device. More particularly, the present disclosure relates to a method for manufacturing a blind hole of an insulating substrate for an electronic device using a photoresist layer.

Description of Related Art

In the past, a blind hole over a glass substrate for an electronic device is usually formed using physical drilling, but this method will produce many dust particles, which causes difficulties in subsequent processes, such as failing to coat ink. Accordingly, in recent years, a blind hole over a glass substrate for an electronic device is formed using chemical etching.

Generally, a resist film is attached to a glass substrate to etch a blind hole of a predetermined region of a glass substrate, the predetermined etched region of the glass substrate is then cut using laser, and the glass substrate is then dipped in an etching solution to form the blind hole of the predetermined region of the glass substrate. However, attachment between the resist film and the glass substrate is poor, and the etching solution will be flowed into a space between the resist film and the glass substrate, resulting in significant side etching phenomenon. Therefore, there is a current need of a novel method for manufacturing a blind hole of an insulating substrate for an electronic device to solve the problems faced by the traditional manufacturing method.

### SUMMARY

In view of the problems faced in the related art, the present disclosure discloses a novel method for manufacturing a blind hole of an insulating substrate for an electronic device using a photoresist layer. The method provided by the present disclosure can obviously improve side etching phenomenon due to an etching solution and decrease residual width of edge of the blind hole, and thus to increase accuracy of forming the blind hole using an wet etching method.

The present disclosure provides a method for manufacturing a blind hole of an insulating substrate for an electronic device. The method includes following steps. A patterned photoresist layer is formed over the insulating substrate. The patterned photoresist layer has an opening exposing a portion of the insulating substrate. A wet etching process is performed to remove the exposed insulating substrate to form a blind hole in the opening.

According to one embodiment of the present disclosure, the insulating substrate is a glass substrate.

According to one embodiment of the present disclosure, forming the patterned photoresist layer over the insulating substrate includes: forming a photoresist layer over the insulating substrate; covering a photomask over the photoresist layer; and performing a photolithographic process to form the patterned photoresist layer.

According to one embodiment of the present disclosure, the photoresist layer is a positive photoresist, and the photomask is a light field photomask.

According to one embodiment of the present disclosure, the photoresist layer is a negative photoresist, and the photomask is a dark field photomask.

According to one embodiment of the present disclosure, performing the wet etching process includes dipping the insulating substrate covered with the patterned photoresist layer into an etching solution containing hydrofluoric acid.

According to one embodiment of the present disclosure, a concentration of the hydrofluoric acid in the etching solution is 10 v/v % to 15 v/v %.

According to one embodiment of the present disclosure, the etching solution further includes hydrochloric acid.

According to one embodiment of the present disclosure, a concentration of the hydrochloric acid in the etching solution is 7 v/v % to 8 v/v %.

According to one embodiment of the present disclosure, the opening is in a shape of rectangle, square, circle, oval, diamond or polygon.

According to one embodiment of the present disclosure, the blind hold has a peripheral region, and the peripheral region has an arc edge, in which the arc edge has a first inclination angle, a second inclination angle and a third inclination angle from bottom to top.

According to one embodiment of the present disclosure, the first inclination angle is 10° to 20°, and the second inclination angle is 40° to 55°, and the third inclination angle is greater than 55°.

### BRIEF DESCRIPTION OF THE DRAWINGS

The invention can be more fully understood by reading the following detailed description of the embodiment, with reference made to the accompanying drawings as follows:

FIGS. 1A-1C are cross-sectional views at various stages of manufacturing a blind hole over an insulating substrate according to some embodiments of the present disclosure; and

FIG. 2 is an enlarged view of a region A of FIG. 1C.

### DETAILED DESCRIPTION

The present disclosure is described by the following specific embodiments. Those with ordinary skill in the arts can readily understand the other advantages and functions of the present invention after reading the disclosure of this specification. The present disclosure can also be implemented with different embodiments. Various details described in this specification can be modified based on different viewpoints and applications without departing from the scope of the present disclosure.

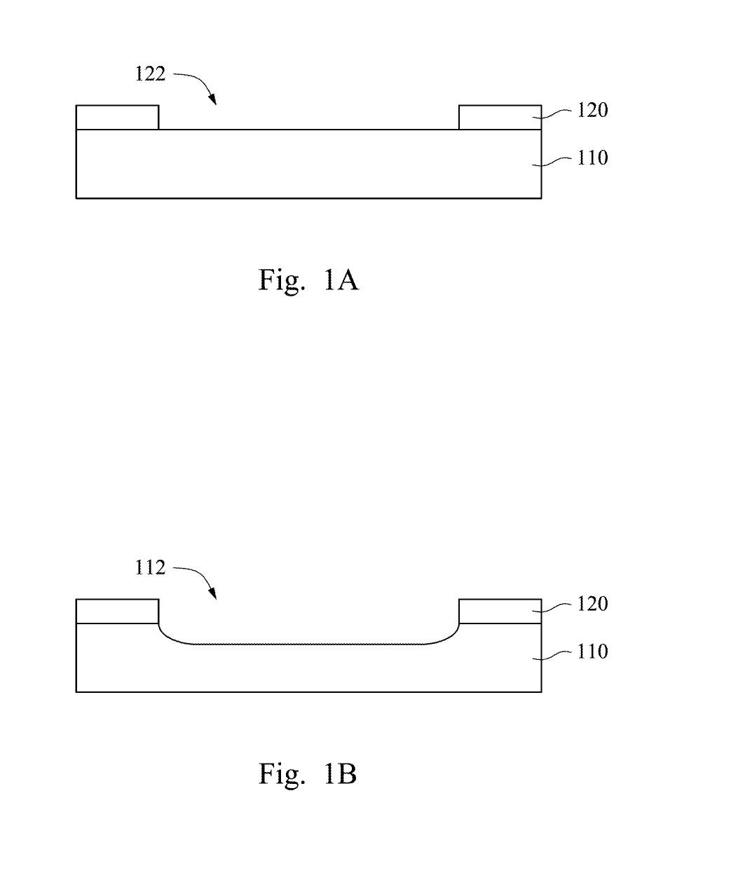

FIGS. 1A-1C are cross-sectional views at various stages of manufacturing a blind hole over an insulating substrate according to some embodiments of the present disclosure. As shown in FIG. 1A, a patterned photoresist layer 120 is formed over an insulating substrate 110, and the patterned photoresist layer 120 has an opening 122 exposing a portion of the insulating substrate 110. According to one embodiment of the present disclosure, the insulating substrate 110 is a glass substrate, such as a sodium glass, aluminum silicate glass, alkali-free glass or other glasses, but not limited thereto. According to one embodiment of the present disclosure, the insulating substrate 110 is used as a cover glass for a fingerprint identification device. According to one embodiment of the present disclosure, the patterned photoresist layer 120 has an opening 122 in a shape of rectangle, square, circle, oval, diamond or polygon.

According to one embodiment of the present disclosure, forming the patterned photoresist layer 120 over the insulating substrate 110 includes following steps. A photoresist layer (not shown) is formed over the insulating substrate 110. A photomask (not shown) covers the photoresist layer. A photolithographic process is then performed to form the patterned photoresist layer 120. According to one embodiment of the present disclosure, the photoresist layer is a positive photoresist, and the photomask is a light field photomask. According to one embodiment of the present disclosure, the photoresist layer is a negative photoresist, and the photomask is a dark field photomask.

Subsequently, a wet etching process is performed to remove the exposed insulating substrate 110 and to form a blind hole 112 in the opening 122, as shown in FIG. 1B. According to one embodiment of the present disclosure, performing the wet etching process includes dipping the insulating substrate 110 covered with the patterned photoresist layer 120 into an etching solution containing hydrofluoric acid. According to one embodiment of the present disclosure, a concentration of the hydrofluoric acid in the etching solution is 10 v/v % to 15 v/v %, preferably 12 v/v %. According to one embodiment of the present disclosure, the etching solution further includes hydrochloric acid. According to one embodiment of the present disclosure, a concentration of the hydrochloric acid in the etching solution is 7 v/v % to 8 v/v %.

According to one embodiment of the present disclosure, the insulating substrate 110 covered with the patterned photoresist layer 120 is dipped in an etching solution containing 12 v/v % hydrofluoric acid and 7-8 v/v % hydrochloric acid at 25° C. with 50 minutes to form the blind hole 112 over the insulating substrate 110. Subsequently, the patterned photoresist layer 120 is removed, as shown in FIG. 1C. According to one embodiment of the present disclosure, the blind hole 112 is in a shape of rectangle, square, circle, oval, diamond or polygon.

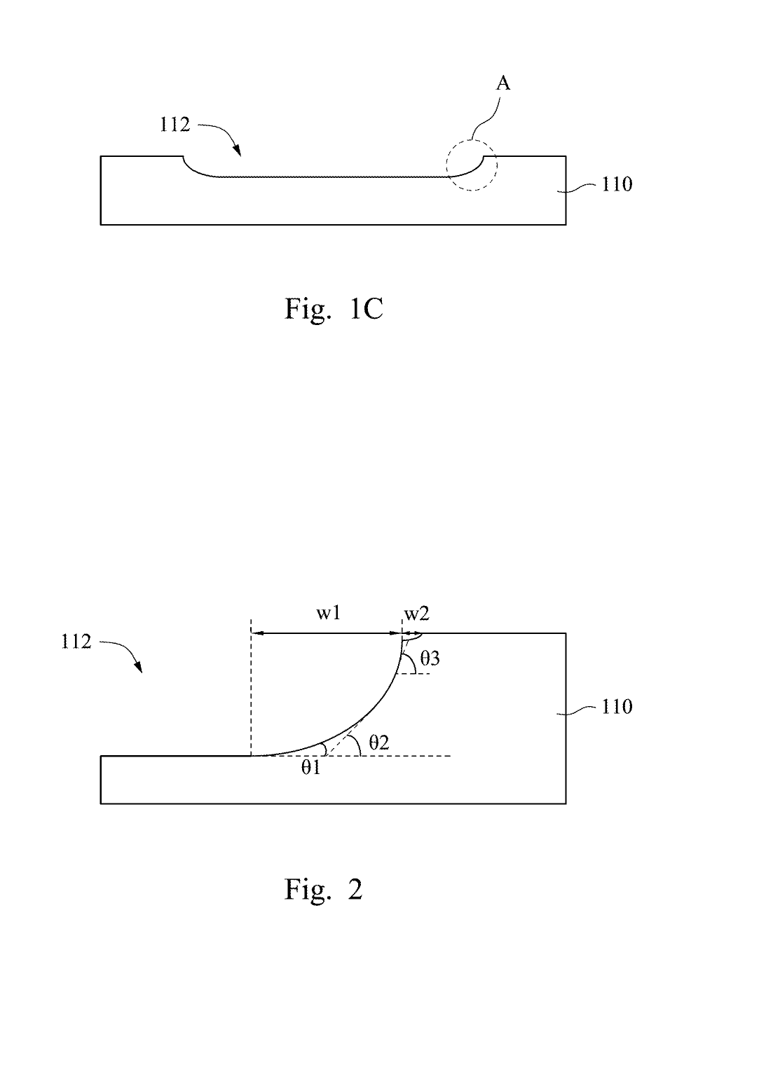

FIG. 2 is an enlarged view of a region A of FIG. 1C. As shown in FIG. 2, a peripheral region of the blind hole 112 has an arc edge extending from an upper surface of the insulating substrate 110 to a bottom of the blind hole 112. The peripheral region of the blind hole 112 can be classified as residual with (w1) and side etching width (w2). The residual width (w1) refers to shortest horizontal distance between a predetermined boundary of the blind hole and the bottom of the blind hole. According to one embodiment of the present disclosure, the residual width (w1) is less than 350 μm. The side etching width (w2) refers to a horizontal distance between the predetermined boundary of the blind hole and an etched upper surface of the insulating substrate. According to one embodiment of the present disclosure, the side etching width (w2) is less than 60 μm. In addition, the arc edge of the peripheral region of the blind hole 112 has a first inclination angle (θ1, taper 1), a second inclination angle (θ2, taper 2) and a third inclination angle (θ3, taper 3) from bottom to top. According to one embodiment of the present disclosure, the first inclination angle (θ1, taper 1) is 10° to 20°, and the second inclination angle (θ2, taper 2) is 40° to 55°, and the third inclination angle (θ3, taper 3) is greater than 55°. Table 1 is residual width (w1), side etching width (w2), first inclination angle (θ1), second inclination angle (θ2) and third inclination angle (θ3) of a blind hole formed using a traditional resist film and those of a blind hole formed using the photoresist layer of some embodiments of the present disclosure.

TABLE 1

| Method of forming blind hole | Using resist film | Using photoresist layer |
|---|---|---|
| residual width (w1) | 525 μm | 263 μm |
| side etching width (w2) | 89 μm | 38 μm |
| first inclination angle (θ1) | 11.2° | 14.6° |
| second inclination angle (θ2) | 51.4° | 49.9° |
| third inclination angle (θ3) | 47.8° | 71.9° |

As shown in Table 1, compared to the blind hole formed using the traditional resist film, the blind hole formed using the photoresist layer of the embodiments of the present disclosure has better performance on the residual width (w1), the side etching width (w2), the first inclination angle (θ1), the second inclination angle (θ2) and the third inclination angle (θ3). For instance, since the blind hole provided by the embodiments of the present disclosure has the smaller residual width (w1) and side etching width (w2), when the insulating substrate provided by the embodiments of the present disclosure is acted as a cover glass of a fingerprint identification device, accuracy of the cover glass can be significantly increased, and assembly tolerance between the cover glass of the fingerprint identification device and other elements can be significantly decreased, and thus to enhance yield of the insulating substrate provided by the embodiments of the present disclosure.

The first inclination angle (θ1), the second inclination angle (θ2) and the third inclination angle (θ3) of the blind hole formed using the traditional resist film are not sequentially increased and do not show an obvious arc, and thus a traditional cover glass exhibits greater residual width (w1), which has lower accuracy and fails to effectively decrease assembly tolerance between the cover glass of the fingerprint identification device and other elements. Therefore, yield of the blind hole formed using the traditional resist film is very low, not to mention wide applications in various electronic devices. In contrast, the blind hole provided by the embodiments of the present disclosure exhibits obvious arc, in which the first inclination angle (θ1), second inclination angle (θ2) and third inclination angle (θ3) are sequentially increased, and thus the insulating substrate provided by the embodiments of the present disclosure has smaller residual width (w1). When the insulating substrate provided by the embodiments of the present disclosure is acted as a cover glass of a fingerprint identification device, overall area of the cover glass can be reduced to increase application range in various electronic devices of the cover glass provided by the present disclosure.

It will be apparent to those ordinarily skilled in the art that various modifications and variations may be made to the structure of the present disclosure without departing from the scope or spirit of the invention. In view of the foregoing, it is intended that the present disclosure cover modifications and variations thereof provided they fall within the scope of the following claims.

What is claimed is:

1. A method for manufacturing a blind hole of an insulating substrate for an electronic device, comprising:
forming a patterned photoresist layer over the insulating substrate, the patterned photoresist layer having an opening exposing a portion of the insulating substrate; and
performing a wet etching process to remove the portion of the insulating substrate to form a blind hole in the opening.

2. The method of claim 1, wherein the insulating substrate is a glass substrate.

3. The method of claim 1, wherein forming the patterned photoresist layer over the insulating substrate comprises:
forming a photoresist layer over the insulating substrate;
covering a photomask over the photoresist layer; and
performing a photolithographic process to form the patterned photoresist layer.

4. The method of claim 3, wherein the photoresist layer is a positive photoresist, and the photomask is a light field photomask.

5. The method of claim 3, wherein the photoresist layer is a negative photoresist, and the photomask is a dark field photomask.

6. The method of claim 1, wherein performing the wet etching process comprises dipping the insulating substrate covered with the patterned photoresist layer into an etching solution containing hydrofluoric acid.

7. The method of claim 6, wherein a concentration of the hydrofluoric acid in the etching solution is 10 v/v % to 15 v/v %.

8. The method of claim 6, wherein the etching solution further comprises hydrochloric acid.

9. The method of claim 8, wherein a concentration of the hydrochloric acid in the etching solution is 7 v/v % to 8 v/v %.

10. The method of claim 1, wherein the opening is in a shape of rectangle, square, circle, oval, diamond or polygon.

11. The method of claim 1, wherein the blind hold has a peripheral region, and the peripheral region has an arc edge, wherein the arc edge has a first inclination angle, a second inclination angle and a third inclination angle from bottom to top.

12. The method of claim 1, wherein the first inclination angle is 10° to 20°, and the second inclination angle is 40° to 55°, and the third inclination angle is greater than 55°.
